(19) United States
(12) Patent Application Publication
(10) Pub. No.: US 2014/0071496 A1
(43) Pub. Date: Mar. 13, 2014

(54) PRINTER, AND PRINTING METHOD AND PROGRAM EXECUTED BY PRINTER

(71) Applicant: CASIO COMPUTER CO., LTD., TOKYO (JP)

(72) Inventor: Atsushi SUKENORI, Higashiyamato-shi, Tokyo (JP)

(73) Assignee: CASIO COMPUTER CO., LTD., TOKYO (JP)

(21) Appl. No.: 14/023,086

(22) Filed: Sep. 10, 2013

(30) Foreign Application Priority Data
Sep. 11, 2012 (JP) 2012-199113

(51) Int. Cl. G06K 15/02

(52) U.S. Cl. CPC G06K 15/024
USPC 358/1.18

(57) ABSTRACT

A printer is provided which includes a pattern input module, a printing module executing printing on a printing medium, and a control unit controlling the input and printing modules, wherein when an input pattern inputted from the input module is inputted into strings of a first string and a second string following the first string with a blank space portion formed at least either at the rear of a first pattern area where a first pattern of the first string is formed or at the front of a second pattern area where a second pattern of the second string is formed, the control unit deletes the blank space portion and arranges the first and second patterns into a single-string pattern array where the first and second patterns are arranged sequentially in that order and causes the printing module to print the pattern array on the printing medium.

### CROSS-REFERENCE TO RELATED APPLICATION

The present invention is based upon and claims the benefit of priority under 35 USC 119 of Japanese Patent Application No. 2012-199113 filed on Sep. 11, 2012, the entire contents of which are incorporated herein by reference.

### BACKGROUND OF THE INVENTION

1. Field of the Invention

The present invention relates to a printer which prints text or a picture on a printing medium, and a printing method and a program which are executed by the printer.

2. Description of the Related Art

There are printers which function as a printing apparatus in which a tape cassette accommodating therein a tape member is loaded and which prints arbitrarily characters or patterns inputted from an input device such as a keyboard module or a touch screen or characters or patterns outputted from other equipment on a printing tape of the tape member for preparing a specific label.

Labels prepared by such printers are now finding a variety of applications, and as a result, those printers adopt types of printing and processes which other label printers do not have in consideration of applications of labels prepared thereby.

For example, in the field of label printers which can print various types of product information and bar codes, a printer is also proposed by, for example, Japanese Unexamined Patent Application No. 07-068853 in which spaces between character strings or orientations of characters are changed according to an increase in the quantity of characters of product information so that as many sentences carrying explanations of a product as possible can be printed on a vertically or horizontally elongated label.

In recent years, as characters to be printed on a label, in addition to characters inputted through keys on the keyboard module, handwritten characters are manually inputted so as to be printed on the label as they are.

When printing a pattern inputted on a printing medium without any change made thereto, patterns are inputted into a plurality of strings on a touch screen. Then, when the patterns in the plurality of strings are printed sequentially into a single string on the printing medium, a space is produce between a pattern inputted into a first string and a pattern inputted into a second string, and this space makes it difficult to read the patterns.

### SUMMARY OF THE INVENTION

According to an aspect of the invention, there is provided a printer including:

an input module which inputs a pattern;

a printing module which executes printing on a printing medium; and

a control unit which controls the input module and the printing module, wherein

when an input pattern inputted from the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,

the control unit deletes the blank space portion and arranges the first pattern and the second pattern into a single-string pattern array in which the first pattern and the second pattern are arranged sequentially in that order and causes the printing module to print the pattern array on the printing medium.

In addition, according to another aspect of the invention, there is provided a printing method executed by a printer including the steps of:

inputting a pattern by an input module;

when an input pattern inputted by the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,

deleting the blank space portion and arranging the first pattern and the second pattern into a single-string pattern array in which the first pattern and the second pattern are arranged sequentially in that order; and

printing the pattern array by the printing module.

Additionally, according to a further aspect of the invention, there is provided a program which instructs a computer to execute the steps of:

causing an input module to input a pattern;

when an input pattern inputted by the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,

deleting the blank space portion and arranging the first pattern and the second pattern into a single-string pattern array in which the first pattern and the second pattern are arranged sequentially in that order, and

causing a printing module to print the pattern array.

Objects and advantages of the invention will be set forth in the following description and in part will be obvious from the description or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

Accompanying drawings, which are incorporated in and constitute a part of the specification, illustrate an embodiment of the invention, and together with the general description given above and a detailed description of the embodiment given below, serve to explain the principles of the invention.

FIG. 1 is a plan view showing an embodiment of a printer according to the invention.

FIGS. 2A and 2B are a perspective view of an example of a tape cassette and an enlarged view of an interior of the printer according to the invention, respectively.

FIG. 3 is a block diagram showing an example of functional blocks of the printer according to the invention.

FIGS. 4A and 4B shows examples of input and conversion of a character pattern in the printer according to the invention.

FIG. 5 is a flowchart showing an example of an input and conversion process in the printer according to the invention.

FIG. 6 is a flowchart showing an example of a character string detection process executed in the printer according to the invention.

FIG. 7 is a flowchart showing an example of a character layout detection process executed in the printer according to the invention.

FIG. 8 is a flowchart showing an example of a line spacing cutting process executed in the printer according to the invention.

### DETAILED DESCRIPTION OF THE INVENTION

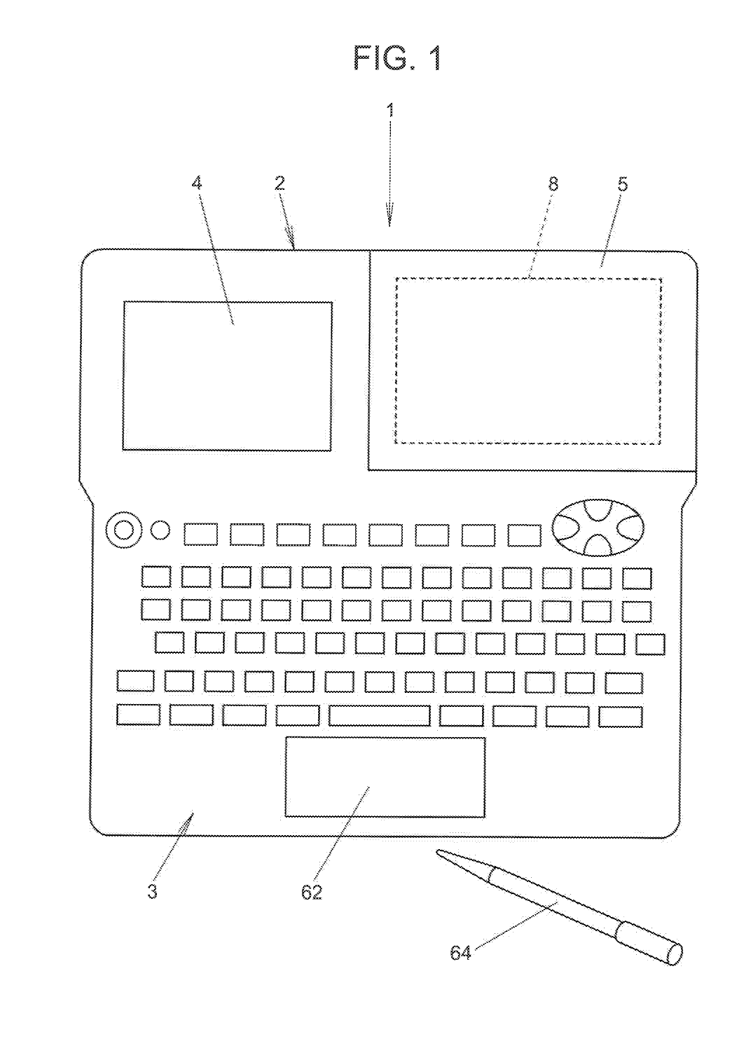

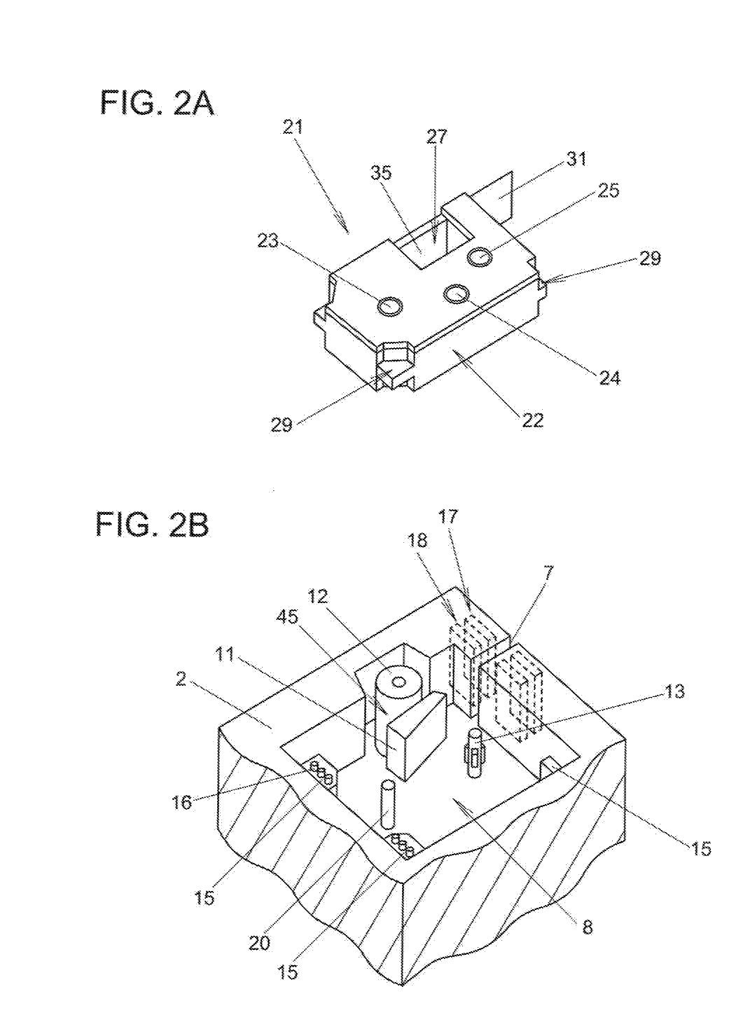

Hereinafter, an embodiment of the invention will be described based on the accompanying drawings. FIG. 1 is a plan view of a printer 1 according to an embodiment of the invention, and FIGS. 2A and 2B are perspective views showing an external appearance of a tape cassette 21 used in the printer 1 and part of an internal construction of the printer 1. The printer 1 is an apparatus which prints an arbitrary pattern on a tape member 31 as a printing member which is formed by laminating a printing tape, which is made up of a printing surface on a front surface thereof and an adhesive surface on a rear surface thereof, and a release tape affixed to the adhesive surface of the printing tape.

As shown in FIG. 1, this printer 1 includes a keyboard input module 3, a display module 4 and a openable lid 5 which closes a tape accommodating portion 8 which are provided on an upper surface of a casing 2. In addition, although not shown, there are formed in the casing 2 input terminals for connection with external equipment such as a computer, a power supply terminal to which a power supply cord is connected, an insertion slot into which a recording medium such as a memory card is inserted and the like.

The keyboard input module 3 includes character input keys with which character data is inputted, a print key with which printing is started, cursor keys with which a cursor is moved on a screen of the display module 4, and various control keys with which setting a printing mode and various setting processes are executed. The display module 4 is a liquid crystal display panel or the like which functions as a main panel on the printer 1. Images based on inputted data, selection menus used for various settings and messages in relation to various processes are displayed on the display module 4.

The printer 1 additionally includes a touch screen display module 62, which is a display device of the invention and which functions as a sub-panel. The printer 1 has a touch pen 64 which is brought into touch with a screen of the touch screen display module 62 so as to designate an on-screen position.

The touch screen display module 62 is a data inputting display panel into which a touch screen as an on-screen position designating device and a liquid crystal display panel as a display device are integrated.

As shown in FIG. 1, the touch screen display module 62 is the small liquid crystal display panel, and therefore, when a label carrying a long sentence is prepared, there are situations in which the whole of such a long sentence cannot be displayed on the touch screen display module 62.

Consequently, when a character string of a long sentence is displayed on the touch screen display module 62, it is designed so that the character string is scrolled so as to move on the screen of the display module in a direction in which the sentence is read to disappear from the screen sequentially.

It is noted that the display module 4 may be configured as a touch screen similar to the sub-panel which includes both functions to designate an on-screen position on the screen by touching it and also to display character, pattern and the like depicted by touching it.

As shown in FIGS. 2A and 2B, the tape accommodating portion 8 is formed inside the openable lid 5 for loading the tape cassette 21 which accommodates therein the tape member 31 and an ink ribbon 35. A tape printing mechanism 45 as a printing module and cassette receiving portions 15 adapted to support the tape cassette 21 in a predetermined position are formed in the tape accommodating portion 8.

The tape printing mechanism 45 includes printing elements which are aligned in a vertical direction, a thermal head 11 which is a printing head, a platen roller 12 which holds the tape member 31 and the ink ribbon 35 between the thermal head 11 and itself to feed them and a ribbon take-up shaft 13 which takes up the ink ribbon 35 used for printing into the tape cassette 21.

In addition, a tape feed-out portion 7 is formed in one end portion of the tape accommodating portion 8 so as to communicate with an exterior of the casing 2. A full-cutting mechanism 17 and a half-cutting mechanism 18 are incorporated in the tape feed-out portion 7. This full-cutting mechanism 17 functions as a full-cutting device which cuts transversely the printing tape and the release tape of the tape member 31, while the half-cutting mechanism 18 functions as a half-cutting device which cuts only the printing tape of the tape member 31.

Further, the tape cassette 21 includes a cassette case 22. A tape core 23 around which the tape member 31 is wound, a ribbon supply core 24 around which an unused ink ribbon 35 is wound, a ribbon take-up core 25 around which the used ink ribbon 35 is taken up are accommodated in the cassette case 22. Additionally, a head installing portion 27 is formed in the cassette case 22 of the tape cassette 21 for the thermal head 11 to be installed when the tape cassette 21 is loaded in the tape accommodating portion 8.

Engagement portions 29 are formed in corner portions of the cassette case 22 so as to be brought into engagement with the cassette receiving portions 15 of the tape accommodating portion 8 to thereby be supported by the cassette receiving portions 15. Although not shown, predetermined projections and recesses which correspond to types of tape cassettes 21 are formed on the engagement portions 29 of the cassette case 22, while predetermined tape width detection switches 16 are formed on the cassette receiving portions 15 of the tape accommodating portion 8 so as to distinguish the projections and recesses formed on the engagement portions 29 of the cassette case 22 when the tape cassette 21 is loaded in the tape accommodating portion 8.

Then, in the printer 1, when the cassette case 22 is loaded in the tape accommodating portion 8, the engagement portions 29 of the cassette case 22 are brought into engagement with some or all of the tape width detection switches 16 formed on the cassette receiving portions 15 in the tape accommodating portion 8, whereby the engaged width detection switches 16 are depressed to be on, and a type or a width of a tape cassette 21 in the cassette case 22 can be distinguished by a combination of tape width detection switches 16 which are switched on.

Namely, in this printer 1, since there are different types of tape cassettes 21 based on widths of tape members 31 incorporated in the tape cassettes 21, the width of a tape or the color of a tape on which printing is to be executed can be identified by distinguishing the type of the tape cassette 21, and a control unit 40 is designed to create printing data suited to the width of the tape.

In the printer 1, when an instruction to execute printing is given to the printer 1, the tape member 31 and the ink ribbon 35 are fed out of the tape cassette 21 and are then held between the platen roller 12 and the thermal head 11 in such a state that the tape member 31 and the ink ribbon 35 are superposed one on top of the other so as to be fed out further.

Then, the thermal head 11 is heated and driven based on the printing data, and ink on the ink ribbon 35 is thermally transferred on to the printing tape of the tape member 31, whereby printing is executed on the printing tape. In addition, when printing is completed, the full-cutting mechanism 17 or the half-cutting mechanism 18 is actuated to operate based on a setting so as to cut the tape member transversely, whereby a label in the form of a tape is prepared.

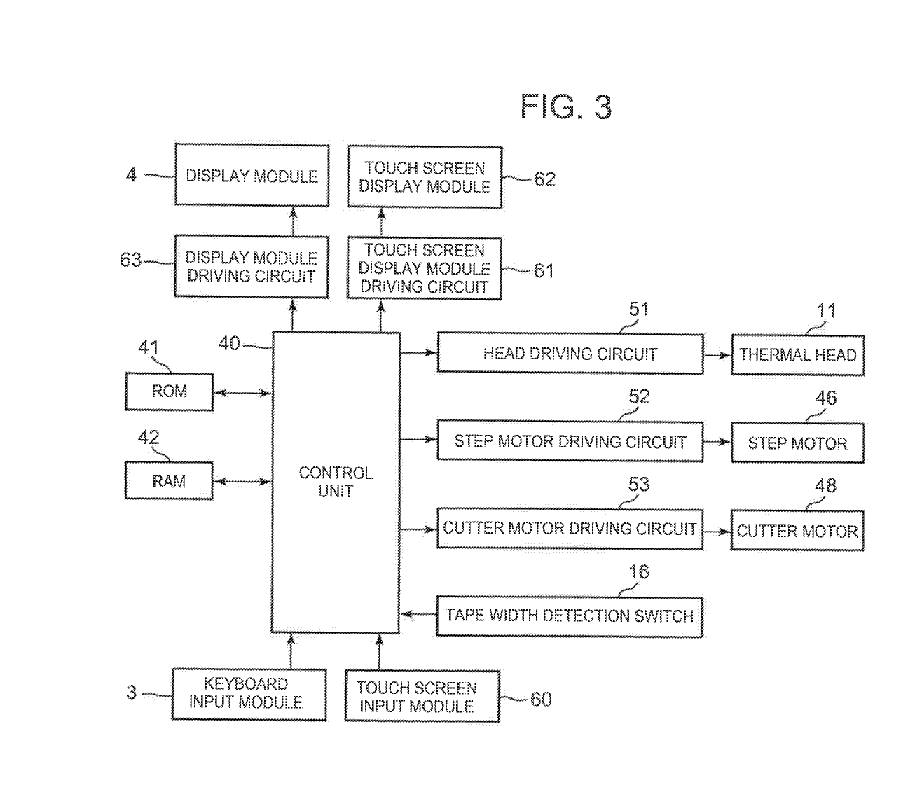

FIG. 3 is a block diagram showing a circuit configuration of the printer 1. As shown in FIG. 3, the printer 1 includes the control unit 40 which governs the whole of a system of the printer 1 and which are designed to function as an on-screen position detection device, a printing data creation device and a printing control device.

Then, a ROM 41 as a storage device, a RAM 42, the keyboard input module 3 as a input portion and a touch screen input module 60 are connected to the control unit 40. When the touch pen 64 is brought into touch with a screen of the touch screen input module 60 to input an on-screen position designation, the control unit 40 functions as the on-screen position detection device so as to detect coordinate data indicating the inputted on-screen position.

Further, a display module driving circuit 63 which drives the display module 4 and a touch screen display module driving circuit 61 as a display control device which drives the touch screen display module 62 are connected to the control unit 40.

This touch screen display module driving circuit 61 drives the touch screen display module 62 as a display device when instructed to do so by the control unit 40. In displaying a character string carrying a long sentence, the touch screen display module driving circuit 61 controls the touch panel display module 62 so that the long character string is scrolled so as to move on the screen of the display module in the direction in which the sentence is read to disappear from the screen sequentially.

Then, when a printing process is executed, the control unit 40 functions as the printing data creation device to create printing pattern data based on character string data stored in a character string data storage device.

A head driving circuit 51, a step motor driving circuit 52 and a cutter motor driving circuit 53, which are designed to drive various mechanisms, are connected to the control unit 40.

The control unit 40 is a CPU and activates in response to key operation signals from the keyboard input module 3 and the touch screen input module 60 or automatically a system program which is stored in advance in the ROM 41, a control program stored in a memory card, a control program read in from external equipment and the like and controls the respective operations of the circuits by the use of the RAM 42 as a working memory.

The ROM 41 also functions as a storage medium in which a program for printing characters inputted from the keyboard input module 3 and the touch screen input module 60, a program for changing display forms of input information and programs which can be read by the control unit 40 are stored.

In the RAM 42, an area for an input data memory which is a character string data storage device which stores data of a character string separated into two strings based on input information inputted from keys on the keyboard module 3, the touch pen and the like, an area for a printing data memory where printing pattern data over which the inputted printing information is deployed is stored, and an area for a display data memory where pattern data which is displayed on the display module 4 and the touch screen display module 62 are stored are ensured, and a register and a counter which store temporarily data necessary for the printing process or the like is provided.

The head driving circuit 51 controls the thermal head 11 which is a printing device based on the printing pattern data so as to execute printing on the tape member 31 which is the printing medium. The step motor driving circuit 52 is a circuit for driving a conveying device and controls a step motor 46 which rotates the platen roller and the ribbon take-up shaft so as to convey the tape member 31 in a longitudinal direction at a predetermined conveying speed. The cutter motor driving circuit 53 is a driving circuit for controlling the full-cutting device, the half-cutting device and the like and controls a cutter motor 48 which is used in the full-cutting mechanism and the half-cutting mechanism.

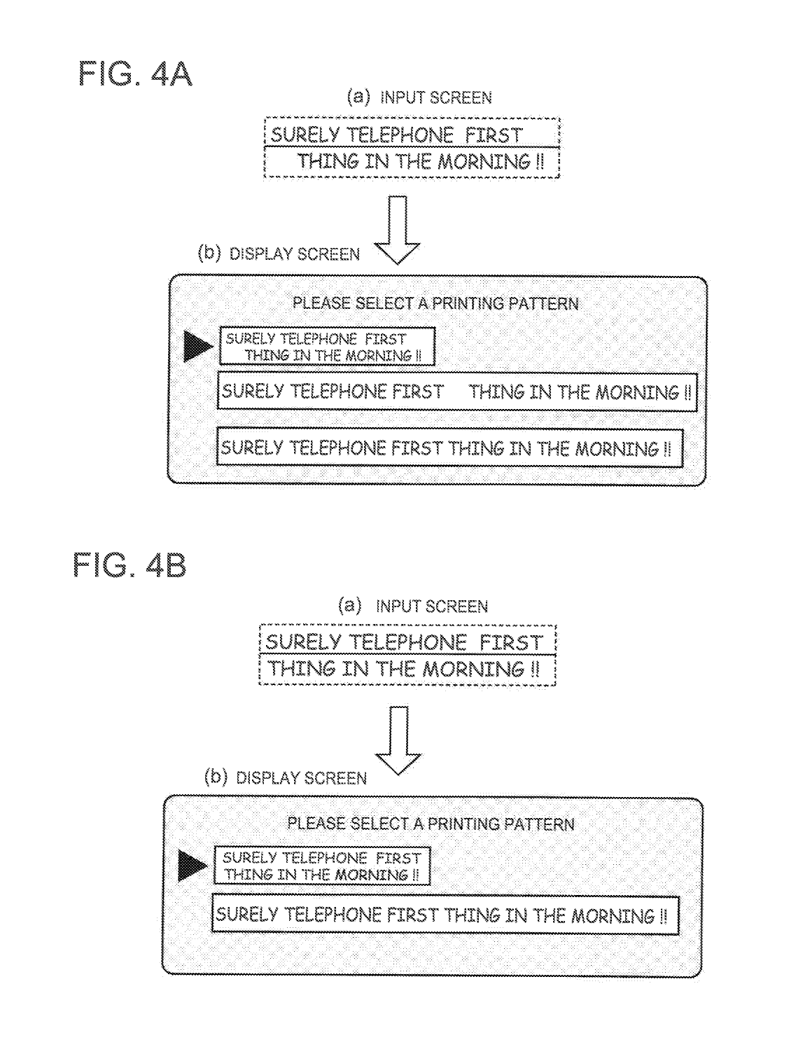

Hereinafter, when a label carrying a plurality of character strings is prepared, a series of steps including a display control executed in the printer 1 will be described in detail by the use of the drawings. FIG. 4 shows display examples in the printer 1 when a label carrying a plurality of character strings is prepared.

FIG. 4A shows an example of manual input of hand written characters into two strings according to the embodiment. As shown in FIG. 4A, when characters are hand written into two strings on the touch screen input module 60 which constitutes an input screen (shown at (a)) with a second string indented, that is, when hand written characters are manually inputted with a large blank space provided at the start of the second or lower string as shown at the input screen (at (a) in FIG. 4A), the following printing patterns are displayed on the display module 4 which constitutes a display screen (shown at (b)) so that any of the printing patterns can be selected. The printing patterns include: a printing pattern which represents the way in which the characters are hand written on the input screen; a printing pattern in which an upper string and the lower string are arranged into a single string with the blank space at the start of the lower string left as it is; and a printing pattern in which the blank space at the start of the lower string is deleted so that spacing between the upper and lower strings is made substantially the same as spacing between constituent characters. In addition, when a blank space is provided at the end of the first string, at least either one of the blank space at the end of the first string or the blank space at the start of the second string may be deleted.

Namely, a pre-display is displayed on the screen of the display module 4 on which printing patterns corresponding to characters inputted are shown, as shown at a display screen shown at (b) in FIG. 4A. The pre-display includes, as printing patterns, an original display which represents the same character strings as that which are inputted on the touch screen input module 60 by hand-writing, a string conversion display which displays a single character string into which the upper character string and the lower character string are simply integrated, and a blank space cutting conversion display which displays a single character string into which the upper character string and the lower character string are integrated with the spacing between the character strings cut. Thus it becomes possible to make the user select any of those printing patterns.

In addition, when characters are hand written to be inputted as input character strings in such a way that the position of a first character of an upper character string is aligned with the position of a first character of a lower character string on the input screen as shown at (a) in FIG. 4B, a pre-display is displayed on the display screen (at (b)). This pre-display includes only the original display which represents the same character strings as that which are inputted on the touch screen input module 60 by hand-writing and the string conversion display which displays the single character string into which the upper character string and the lower character string are continuously integrated, so that the user can select either the printing pattern which represents just like what is shown on the input screen or the printing pattern which represents the single continuous character string.

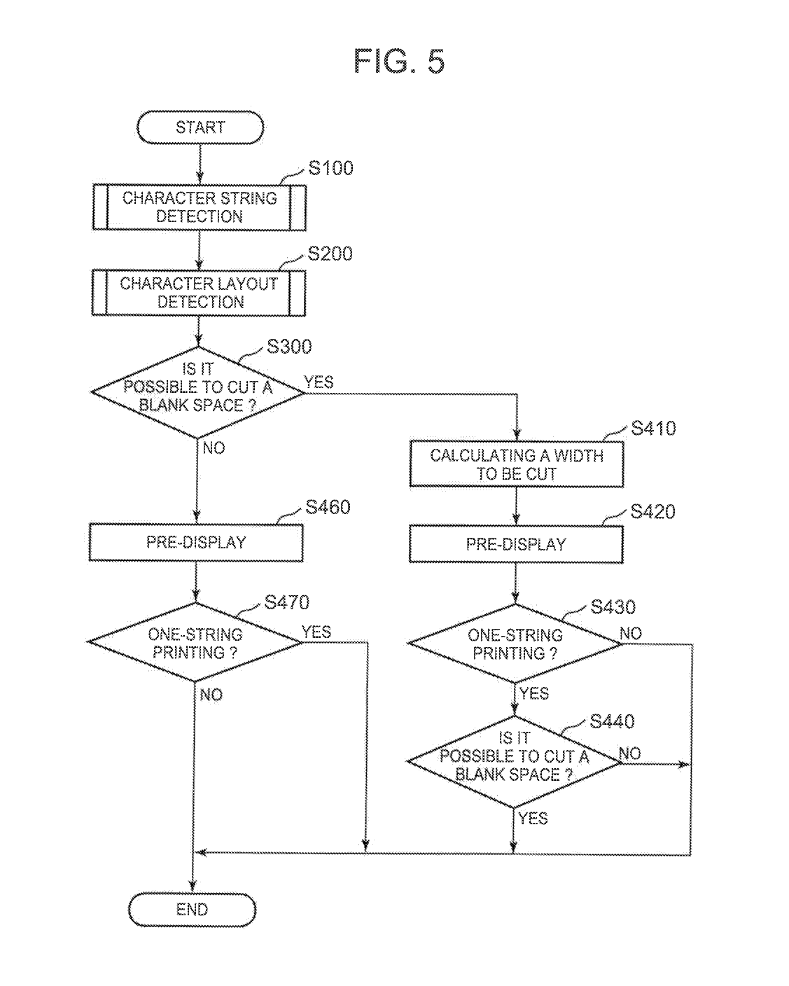

In a printing pattern changing process which enables the selection between the printing pattern which represents the hand-written input with no change and the printing pattern which represents the single continuous character string, after the hand-written input has been made, as shown in FIG. 5, firstly, a character string detection process (S100) is executed to determine whether the hand-written input is a single string input or an input of a plurality of strings. In addition, a width of a character string or a width of each of the plurality of character strings is detected. When the hand-written input is made into the plurality of character strings, spacing between the strings is also detected.

Further, a character layout detection process (S200) is executed. In this character lay out detection process, a blank space at the start of each character strings is detected, and spacing between characters is also detected. Additionally, when the printing pattern is changed to the single continuous string printing patter, it is determined whether or not a blank space at the start of each strings can be cut based on the length of the blank space at the start of a second string and later (S300). In addition, when a blank space is present at the end of the first string, it may be determined whether or not at least either the blank space at the end of the first string or the blank space at the start of the second string can be cut.

Then, in the event that the blank space cutting cannot be executed due to the first character of the first string being aligned with the first character of the second string and later, as shown in FIG. 4B, a pre-display is executed (S460) which displays the printing pattern representing the hand-written input of the two strings and the printing pattern representing the single continuous character string on the display module. Then, it is determined whether or not the single continuous character string printing be executed according to an input selected by the user, that is, whether the hand-written input is printed as it is or it is printed into a single continuous character string (S470), and the printing pattern changing process is ended. In addition, as this occurs, in the event that a blank space is present at the end of the first string, it may be determined whether or not the blank space at the end of the string can be cut.

In addition, in the event that the second string and later are indented and a blank space at the start of the second string and later is larger than a predetermined value, a width to be cut is calculated according to the length of the blank space at the start of the second string and later (S410). When the hand-written input is an input of two character strings, as shown in FIG. 4A, the pre-display is executed which displays the original display which represents the printing state of the hand-written input of two character strings, the string conversion display which represents the printing state in which the two character strings are arranged into a single character string with the length of a blank space at the start of the second string left as it is, and the blank space cutting conversion display which represents the printing state in which the two character strings are arranged into a single character string with the blank space at the start of the second string cut (S420). By selecting and inputting of the selected printing state which is made by the user, it is determined whether to execute the printing according to the original display or the single-character string printing which involves the string conversion process (S430). When the single-character string printing is selected to be executed, it is determined whether or not the printing is executed which involves the blank space cutting conversion process by which the originally inputted two character strings are arranged into the single character string with the blank space between the two strings cut (S440), whereafter the printing pattern changing process is ended. In addition, in the event that a blank space is present at the end of the first string, a width to be cut may be calculated for at least either the blank space at the end of the first string or the blank space at the start of the second string.

After executing this printing pattern changing process, the size of printing is determined according to the string width of the character string and the width of the tape member, whereby printing is executed through a printing process.

In the character string detection process (S100) as part of the printing pattern changing process, the detection as to whether or not dots aligned in the direction of a horizontal line in each of lines of a memory frame are individually made to be “ON” when the character is inputted in handwriting is executed, and the same detection is executed sequentially line byline in a vertical direction. Additionally, in the character layout detection process (S200), dots aligned in the same vertical column are individually detected as to whether or not a dot is made to be “ON”, and the same detection is executed sequentially column by column in a horizontal direction.

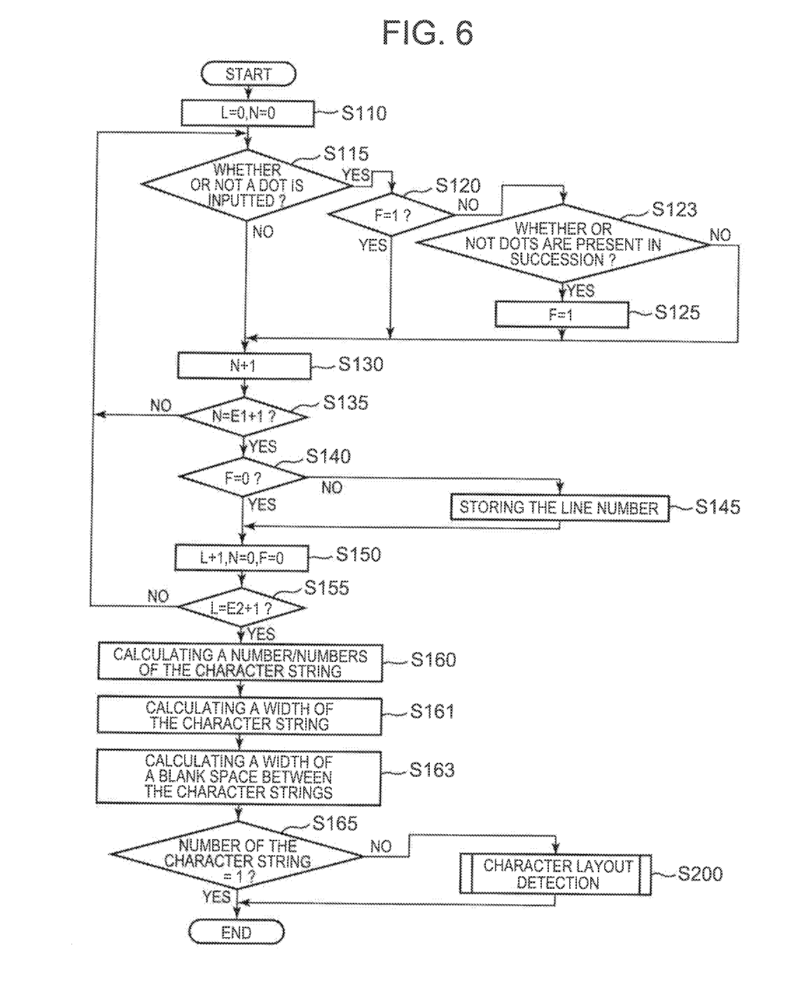

Namely, in the character string detection process (S100), as shown in FIG. 6, firstly, a starting number “0” is set to a line number (L) of a line in the horizontal direction, and a starting number “0” is also set to a column number (N) (S110).

Then, it is determined whether or not a dot at the address of “0, 0” is made to be “ON” by hand-writing on a screen of the touch screen input module 60 (S115). If a dot is not made to be “ON” at that address, “1” is added to the column number (N) (S130), and then it is sequentially determined in each of columns of the starting line one by one whether or not a dot is made to be “ON” (S115) and it is determined whether or not the detection of the dot which is made to be “ON” (hereinafter referred to as “ON dot”) is repeatedly executed until a final column (E1) in the starting line (S135), whereby it is determined whether or not a dot/dots is/are made to be “ON” in the starting line which is a predetermined line.

Then, when a “ON” dot is detected, it is determined whether or not there exists a stored record of consecutive “ON” dots in the line concerned (S120). If it is determined that there exists no such record, it is determined whether or not there consecutively exists a dot/or dots which is/are made to be “ON” subsequent to the dot which has been determined to be “ON” (S123). If it is determined that there exists consecutive “ON” dots in the line concerned, a flag (F) is set which indicates the existence of consecutive “ON” dots, and the existence of the consecutive “ON” dots is stored in the record (S125).

Further, based on the determination (S135) made as to whether or not a dot is made to be “ON” until the final column number (E1), when it is determined that the line concerned is completely detected, it is determined whether or not there exist a plurality of consecutive “ON” dots (S140). If there is no record of such consecutive “ON” dots, a process is executed in which “1” is added to the line number (L), while the column number (N) is returned to “0,” and the flag (F) which is set to indicate that there are consecutive “ON” dots is returned to “0” (S150).

In addition, as a result of the determination on the existence of consecutive “ON” dots (S140) after the detection of one line is completed, in the event that the record (F) is set which indicates the existence of such consecutive “ON” dots, the line number of the line concerned is stored (S145), and thereafter, a process is executed in which “1” is added to the line number (L), while the column number (N) is returned to “0” and the flag (F) which is set to indicate the existence of consecutive “ON” dots is returned to “0” (S150).

Then, it is determined whether or not the number of the line which has just been detected exceeds a final line number (E2) (S155). If a final line has not yet been reached, the same detection for “ON” dots is executed repeatedly in each columns of the following line (S115), and it is also determined repeatedly whether or not there is a record of consecutive “ON” dots(S120).

The horizontal lines are detected in this way sequentially in the vertical direction until the final line number (E2) is reached. Thereafter, the number of the character strings inputted is calculated based on a consecutive state of a “ON” dot in the line numbers (L) in which there exists a “ON” dot and a consecutive state of a dot which is not made to be “ON” (hereinafter referred to as “OFF dot”) in the line numbers (L) in which there no exists “ON” dot (S160), and then, the number of character strings inputted is stored. Further, a string width of a character string is calculated based on the size and alignment of characters (S161), and when a plurality of character strings are inputted, the width of blank space between the character strings is calculated (S163). In the case of the plurality of character strings being inputted, the character string detection process (S100) is also executed in which the existence of a blank space at the start of each character string is detected.

In addition, when only a single character string is inputted or when characters in an upper string and characters in a lower string partially intersect, the character string detection (S100) is ended, and a normal character string starting position detection and character string end detection are executed to specify a range where characters are inputted, so as to determine a size of printing to be made on to the tape member.

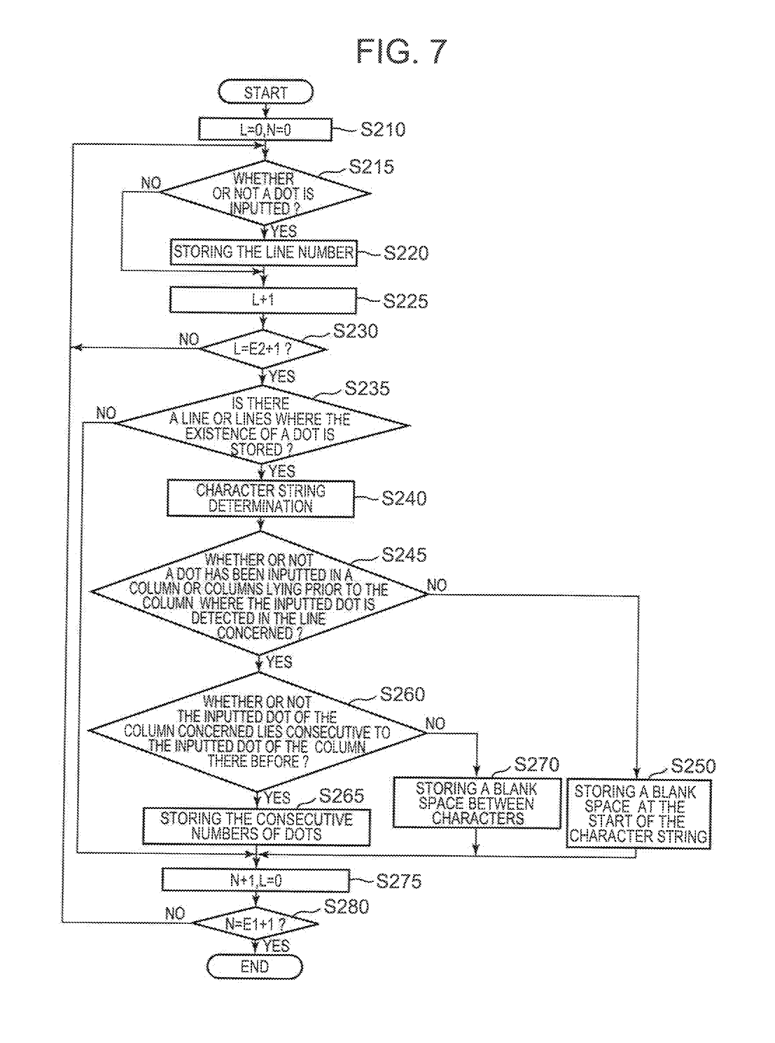

In the character layout detection process (S200), as shown in FIG. 7, firstly, a starting number “0” is set to the line number (L) of a line in the horizontal direction, and a starting number “0” is also set to the column number (N) (S210).

Thereafter, it is detected whether or not a dot at the address of “0, 0” in the line concerned is made to be “ON” (S215). If the “ON” dot is detected at that address, the line number is stored (S220), whereas if the dot is not made to be “ON”, nothing is executed, and then, “1” is added to the line number (L) (S225). Then, it is determined whether or not the detection of “ON” dot is executed until the final line number (E2) (S230), when it is determined that the detection has not yet been executed until the final line, the detection of whether or not a dot is made to be “ON” in the same column of the following line (S215) and the addition of “1” to the line number (L) (S225) are executed repeatedly.

Then, based on the determination (S230) of whether or not a dot at each columns in each lines is made to be “ON” until reaching the final line number (E2), when it is determined that the detection has been executed until the final line, it is determined whether or not there is a line or lines where the existence of a “ON” dot is stored (S235). When it is determined that there is a record of a line or lines where there exists a “ON” dot, a character string determination (S240) is executed in which it is determined whether or not the “ON” dot is existed in any of the character strings, for example in an upper string or in lower string of the character strings, based on the record of the line number where there exists a “ON” dot. Additionally, it is determined whether or not a dot is made to be “ON” in any columns lying before the column where the “ON” dot is detected in the line concerned (S245). If it is determined that there no exists any columns in which a “ON” dot has been existed before the column concerned, it is determined that such column is positioned at the start of the character string, thus, a blank space at the start of the character string is stored (S250).

In addition, when there exists an “ON” dot in any of columns before the column concerned in the character string, it is determined whether or not the “ON” dot of the column concerned exists consecutive to the “ON” dot of the column therebefore in the character string concerned (S260). If the “ON” dots are present in the consecutive columns, the consecutive numbers of “ON” dots lying consecutive to each other is stored as a character width of the character inputted (S265). In contrast, based on the determination (S260) of whether or not the “ON” dots are present in the consecutive columns, when the “ON” dot of the column before the column concerned is determined not to exist consecutive to the “ON” dot of the column concerned but the column before the column concerned is determined as an independent column in which a “ON” dot exists newly, the number of “OFF” dots in consecutive columns in which a “ON” dot is not existed is calculated as a blank space width between characters, based on the number of columns from the final column of the previous consecutive columns whose “ON” dots exist to the independent column, so as to be stored as a blank space between characters (S270).

After the storage of the blank space widths (S250), (S270) and the character width (S265), or when it is determined based on the determination (S235) of whether or not there are lines where the existence of “ON” dot are stored through the detection made to the final column that there is no line where a “ON” dot exists, a process (S275) is executed in which “1” is added to the column number (N), while the line number (L) is returned to the starting number “0.” Then, it is determined whether or not the detection is executed to the final column number (E1) (S280). Then, if it is determined that the detection has not yet been completely executed to the final column, returning to the first dot of the subsequent line, it is determined whether or not the dot is made to be “ON” (S215), and the character layout detection process (S200) is continuously executed. Then, when the detection is completely executed to the final column, the character layout detection process (S200) is ended.

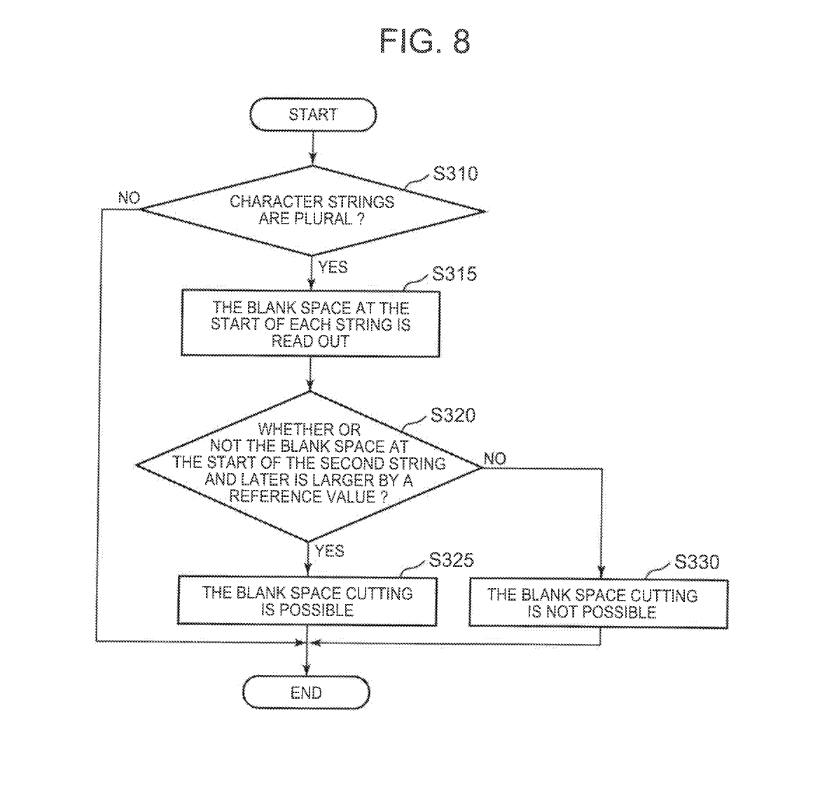

Then, in the determination of whether or not the blank space cutting conversion process is executed as shown in FIG. 8, firstly, it is determined whether or not character strings are plural (S310), and if there are a plurality of character strings, the blank space at the start of each string which is calculated in the character layout detection process (S200) is read out(S315), and it is determined whether or not the blank space at the start of the second string and later is larger than the blank space at the start of the first string and a difference between the blank space at the start of the first string and the blank space at the start of the second string and later is larger than a reference value (S320). If the difference is larger than the reference value (including reference value), it is determined that the blank space cutting is possible (S325), while the difference is less than the reference value (not including the reference value), it is determined that the blank space cutting is not possible (S330). In addition, in the event that a blank space is present at the end of the first string, it may be determined whether or not at least either the blank space at the end of the first string or the blank space at the start of the second string can be cut.

The reference value takes a predetermined value such as a value ranging from 50 dots to 100 dots in terms of the number of columns or is set to one half to on the order of two thirds the size of the character at the start of the highermost string which is detected in storing the number of consecutive “ON” dots (S265) in the character layout detection process (S200).

By providing the reference value in this way, even though the start positions of the first characters in each character strings are slightly different with each other as a result of the hand-written input, a small difference does not have to be corrected, and only a large difference which would interrupt the reading of a resulting character string is corrected so as to make it easy to read the character string.

Consequently, when the start position of the character at the start of a lower string recedes more largely than the predetermined reference value from the start position of the character at the start of an upper string of two character strings into which hand-written characters are inputted, by executing the blank space cutting conversion process to cut a blank space at the start of the lower string in such a way as to delete the blank space which results from the receding of the lower string, the two character strings can be converted into a hand-written input of a single character line without providing an excessive space between the upper string and the lower string which are combined together for printing, whereby an easily readable printing can be realized without wasting the tape member 31. In addition, in the event that a blank space is present at the end of the first string, at least either the blank space at the end of the first string or the blank space at the start of the second string may be deleted.

In deleting the blank space portion resulting from the receding of the character at the start of the lower string, there may be a situation in which spacing between a final character of the upper string and the character at the start of the lower string is set according to an average distance of the blank space width between characters detected in the character layout detection process (S200).

Additionally, the character layout detection process (S200) can also be simplified so as to execute only the detection of a blank space at the start of a character string so that the position of a character at the start and the position of a character at the end of a character string are detected. Then, in this process, it is determined whether or not the blank space cutting is possible based on the different amounts between start positions of the first characters at the start of each character strings, and additionally, there may be a situation in which the amount of blank space cutting is determined.

In addition, the character layout detection process (S200) can also be used not only to detect the blank space at the start of a character string but also to detect a blank space at the end of the character string, and in this case, the character layout detection process (S200) can also be used also when a blank space is formed at least either at the end of a first string or at the start of a second string.

Further, In the embodiment, a hand-written input is executed on the touch screen input module 60 of the printer 1, and the input information from the touch screen input module 60 is processed whereby the string conversion process and the blank space cutting conversion process is executed. However, the same process can be executed on hand-written characters images of which are scanned or hand-written characters which are inputted into the printer 1 based on character information inputted into a touch screen input module of other personal computers.

While the embodiment of the invention has been described heretofore, the embodiment is illustrated as the example of the printer of the invention, and hence, there is no intention to limit the scope of the invention by the embodiment. This novel embodiment can be carried out in various other forms, and various omissions, replacements and/or modifications can be made without departing from the spirit and scope of the invention. These embodiments and their modifications are contained in the spirit and scope of the invention and are also contained in the scope of inventions which are to be claimed hereinafter and their equivalents.

What is claimed is:

1. a printer comprising:
an input module which inputs a pattern;
a printing module which executes printing on a printing medium; and
a control unit which controls the input module and the printing module, wherein
when an input pattern inputted from the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,
the control unit deletes the blank space portion and arranges the first pattern and the second pattern into a single-string pattern array in which the first pattern and the second pattern are arranged sequentially in that order and causes the printing module to print the pattern array on the printing medium.

2. The printer according to claim 1, wherein
the control unit deletes the blank space portion when the length of the blank space portion is a predetermined length or more.

3. The printer according to claim 2, wherein
the control unit arranges the first pattern and the second pattern into a single-string pattern array in which the first pattern and the second pattern are arranged sequentially without deleting the blank space portion when the length of the blank space portion is less than the predetermined length.

4. The printer according to claim 3, wherein
the predetermined length is a length which falls within a range from 50 dots or more to 100 dots or less.

5. The printer according to claim 3, wherein
the predetermined length is a length which falls within a range from one half or more to two thirds or less the size of a pattern at the start of the first pattern.

6. The printer according to claim 1, wherein
the control unit sets spacing between the first pattern and the second pattern based on an average distance between the patterns when the control unit deletes the blank space portion.

7. The printer according to claim 1, comprising further:
a display module which displays the patterns, wherein
the display module executes a pre-display which displays:
an original display which represents the input pattern which is inputted from the input module;
a string conversion display which represents a single string into which the first pattern and the second pattern are sequentially arranged without deleting the blank space portion; and
a blank space cutting conversion display which represents a single string into which the first pattern and the second pattern are sequentially arranged with the blank space portion deleted.

8. A printing method executed by a printer comprising the steps of:
inputting a pattern by an input module;
when an input pattern inputted by the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,
deleting the blank space portion and arranging the first pattern and the second pattern into a single-string pattern array in which the first pattern and the second pattern are arranged sequentially in that order; and
printing the pattern array by the printing module.

9. The printing method executed by the printer according to claim 8, wherein
the blank space portion is deleted when the length of the blank space portion is a predetermined length or more.

10. The printing method executed by the printer according to claim 9, wherein
the first pattern and the second pattern are arranged into a single-string pattern array in which the first pattern and the second pattern are arranged sequentially without deleting the blank space portion when the length of the blank space portion is less than the predetermined length.

11. The printing method executed by the printer according to claim 10, wherein
the predetermined length is a length which falls within a range from 50 dots or more to 100 dots or less.

12. The printing method executed by the printer according to claim 10, wherein
the predetermined length is a length which falls within a range from one half or more to two thirds or less the size of a pattern at the start of the first pattern.

13. The printing method executed by the printer according to claim 8, wherein
spacing between the first pattern and the second pattern is set based on an average distance between the patterns when the blank space portion is deleted.

14. The printing method executed by the printer according to claim 8, wherein
a pre-display is displayed on a display module,
the pre-display displaying:
an original display which represents the input pattern which is inputted from the input module;
a string conversion display which represents a single string into which the first pattern and the second pattern are sequentially arranged without deleting the blank space portion; and
a blank space cutting conversion display which represents a single string into which the first pattern and the second pattern are sequentially arranged with the blank space portion deleted.

15. A program which instructs a computer to execute the steps of:
causing an input module to input a pattern;
when an input pattern inputted by the input module is inputted into a plurality of strings which include a first string and a second string which follows the first string with a blank space portion formed at least either at the rear of a first pattern area where a first pattern of the first string is formed or at the front of a second pattern area where a second pattern of the second string is formed,
deleting the blank space portion and arranging the first pattern and the second pattern into a single-string pattern array in which the first pattern and the second pattern are arranged sequentially in that order, and
causing a printing module to print the pattern array.

16. The program according to claim 15, wherein
the blank space portion is deleted when the length of the blank space portion is a predetermined length or more.

17. The program according to claim 16, wherein
the first pattern and the second pattern are arranged into a single-string pattern array in which the first pattern and the second pattern are arranged sequentially without deleting the blank space portion when the length of the blank space portion is less than the predetermined length.

18. The program according to claim 17, wherein
the predetermined length is a length which falls within a range from 50 dots or more to 100 dots or less.

19. The program according to claim 17, wherein
the predetermined length is a length which falls within a range from one half or more to two thirds or less the size of a pattern at the start of the first pattern.

20. The program according to claim 15, wherein
spacing between the first pattern and the second pattern is set based on an average distance between the patterns when the blank space portion is deleted.
